(19) United States
(12) Patent Application Publication
(10) Pub. No.: US 2006/0138771 A1
(43) Pub. Date: Jun. 29, 2006

(54) Braze-free connector for joining a pair of flow lines

(75) Inventors: Timothy Galante, West Hartford, CT (US); Sivakumar Gopalnarayanan, Simsbury, CT (US); Robert Dold, Agawam, MA (US)

Correspondence Address: WALL MARJAMA & BILINSKI, 101 SOUTH SALINA STREET, SUITE 400, SYRACUSE, NY, 13202, US

(73) Assignee: Carrier Corporation, Syracuse, NY (US)

(21) Appl. No.: 11/025,350

(22) Filed: Dec. 27, 2004

(51) Int. Cl. F16L 47/00

(52) U.S. Cl. 285/249

(57) ABSTRACT

A braze-free connector for joining a pair of flow lines in leak tight manner. The connector has a tubular body with entranceways at each end face of the body that converge inwardly and open into the central passage of the body. A flow line is inserted into the body through each entranceway so that the lines meet in abutting contact at about the midsection of the body. A collapsible metal ferrule surrounds each of the lines and is at least partially housed within each entranceway. Members having internal threads that are mated with external threads on the body are arranged to advance the ferrules into the entranceway whereupon the ferrules are forces radially into metal to metal sealing contact with the tubes by the converging wall surfaces of the entranceways.

### FIELD OF THE INVENTION

This invention relates to a braze-free connector for providing a strong leak tight joint between two flow lines.

### BACKGROUND OF THE INVENTION

This invention is more specifically related to a connector for use in an air conditioning or refrigeration system for establishing a braze-free joint between a pair of refrigerant lines. A great deal of the reliability associated with an air conditioning system relies to a large extend upon the skill of the installer. This is particularly true with regard to split systems where one of the system heat exchangers and the system compressor are located outdoors and the remaining system components are located indoors. This type of system requires long flow lines to properly interconnect the various component parts of the system. The lines connecting the indoor components to the outdoor components are typically broken into sections which must be connected together at the time of installation to establish leak tight joints at the connections.

A study was recently conducted which found that brazing line to line joints is one of the most difficult tasks faced by an air conditioner installer requiring a great deal of skill to properly complete. Failure to properly close the joint connection leads to premature leakage problems which adversely effects the charge level within the system. Lack of charge, in turn, causes the system to operate at a low efficiency and will eventually lead to a complete system failure. In a typical installation, a good deal of time and effort is spent in carrying out the line brazing procedures to insure the integrity of the system.

The brazing of the flow lines also requires that the installer bring a torch to the job and heat the lines at the connections to a relatively high temperature at which most brazing materials melt. Under a controlled environment, a skilled technician can braze two sections of lines together without much difficulty. However, the conditions at most split system installations are generally less than ideal and the installer is forced to complete the brazed connections close to the ground or near structures that can be damaged by the high brazing temperatures.

Attempts have been made in the prior art to connect refrigerant lines without the need of brazing the joints between lines. However, these efforts, for the most part, have not been successful and leak problems are encountered at the relatively high line pressures found in most air conditioning systems.

### SUMMARY OF THE INVENTION

It is an object of the present invention to improve braze-free line to line connections in flow systems, generally, and in air conditioning and refrigeration systems, specifically.

A further object of the present invention is to reduce the time required to install an air conditioning or refrigeration system.

A still further object of the present invention is eliminate the need to braze line to line connections particularly in difficult to reach places where high brazing temperatures may cause damage to neighboring structures or pose a fire hazard.

These and other objects of the present invention are attained by braze-free connectors for joining two flow lines so that a fluid can flow through the joint region in a leak tight manner. The connector includes a tubular body having a central passage passing therethrough and having external male threads located upon either end of the body. Entranceways are located at each end of the connector body that have inner wall surfaces that converge inwardly from the end faces of the connector and towards the central passage. Flow lines are passed into the body through the entranceways and the lines are placed in abutting contact at the midsection of the body. A ferrule surrounds each of the lines and is mounted, at least partially, within one of the entranceways. Each ferrule is mounted inside an internally threaded member that is mated with the external threads upon the tubular body. The ferrules are advanced into the entranceway as the threaded members are screwed onto the body, and thus driven radially into sealing contact with the refrigerant lines. O-ring seals are located within the body forward of the ferrules to further seal the connection between the lines.

### BRIEF DESCRIPTION OF THE DRAWINGS

For a better understanding of these and objects of the present invention, reference will be made to the following detailed description of the invention which is to be read in association with the accompanying drawings, wherein:

FIG. 1 is a perspective view of a connector embodying the teachings of the invention; and

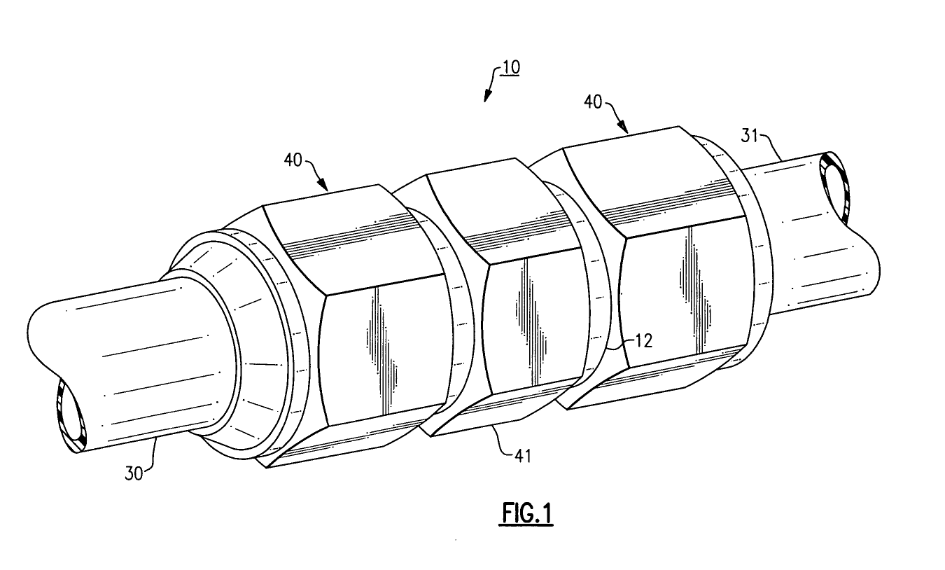

FIG. 2 is a side elevation in section of the connector shown in FIG. 1.

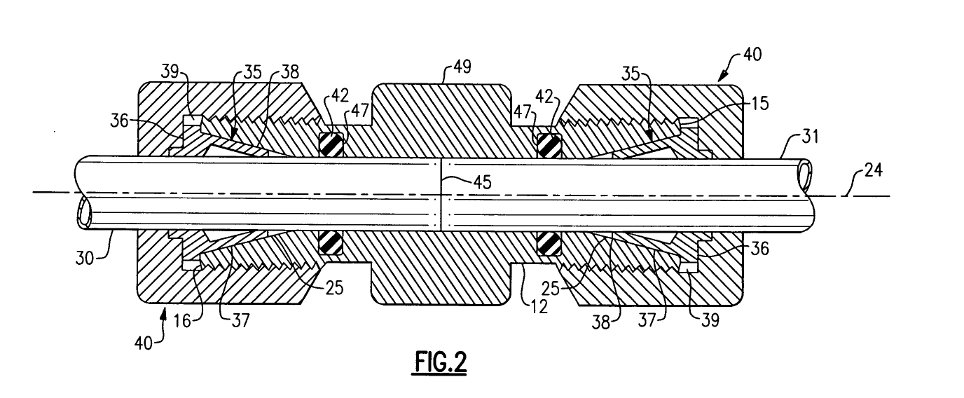

### DETAILED DESCRIPTION

Turning now to the figures, there is illustrated a flow line connector generally referenced 10, that embodies the teachings of the present invention. The connector includes a tubular body 12 that contains a central passage 13 which passes through the body between a first end face 15 and a second end face 16. The outer surface of the body contains a series of external male threads 18 at either end of the body, the function of which will be explained in greater detail below. A first tapered entranceway 20 passes into the body through first end face 15 while a second similar entranceway 21 passes into the body through the second end face 16. The two entranceways are coaxially aligned with the central passage 13 of the body along a common axis 24. Each entranceway contains a conical shaped inner wall 25 surface that converges inwardly from the end face and opens into the central passage from one end face toward an opening in the central passage.

As noted above, the present connector is ideally suited for use in air conditioning or refrigeration systems which typically employ copper flow lines and which operate at relatively high pressures. A metal first flow line 30 is passed into the connector body through entranceway 20 and a second metal flow line 31 is similarly passed into the connector body through the second entranceway 21. The flow lines, in assembly, are brought into abutting contact within the midsection of the body. A close running fit is provided between the inside wall of the central passage and the outer wall surface of each flow line.

Prior to insertion of the flow lines into the connector body, a collapsible metal ferrule 35 is passed over each line. Each ferrule includes an end flange 36 and a conical shaped section 37 that extends outwardly from the end flange. The end section of each ferrule contains a relatively thin wall that tapers inwardly from the end flange to the tip 38 of the ferrule. The outer wall surface of each end section compliments the inner wall surfaces of the associated entranceway. The flange of each ferrule is rotatably mounted within a groove contained within an internally threaded member 40 which is passed over a flow line with the contained ferrule as a unit. Preferably, each internal threaded member is a hex headed nut. With the two flow lines placed in abutting contact within the body, the ferrule and nut units are brought forward and the nuts are threaded onto the external threads of the connector body. As the nuts are advanced, the end sections of the ferrules are driven inwardly in a radial direction by the inner wall surfaces of the entranceways. The tips of the ferrules are driven into metal to metal contact with the outer wall surfaces of the flow lines and forced into sealing contact with the flow lines to create a metal to metal leak tight joint between each ferrule and the associated flow lines.

Each nut is provided with a break away feature which is arranged to prevent further rotation of the nut in either direction when a sufficient force has been applied to the ferrules to insure that a leak tight joint has been established at each end of the connector. Accordingly, once the joints have been established and the nut is locked in place, the connection between the lines becomes permanent. The body 12 of the connector has a raised hex-shaped section 41 that can be held by wrench as the nuts are tightened. Although the invention has been described with specific reference to break away nuts, it should be made clear that other types of drives such as lever arms and the like may be similarly employed to force the ferrules into the entranceways and thus into sealing contact with the flow lines. To further insure the integrity of the joint, O-ring seals 42 are mounted in the connector body on either side of the joint 45 between the flow lines. The O-rings are carried within grooves 47 formed in the inner wall of passage 13.

While the present invention has been particularly shown and described with reference to the preferred mode as illustrated in the drawings, it will be understood by one skilled in the art that various changes in detail may be effected therein without departing from the spirit and scope of the invention as defined by the claims.

1. A braze-free connector for providing a leak tight joint between a first flow line and a second flow line, said connector including:
a body having a flow passage extending between a first end face and a second end face;
said passage having a first converging entranceway passing inwardly through said first end face and a second converging entranceway passing inwardly through said second end face;
a first flow line passing into said body through said first entranceway and a second flow line passing into said body through said second end face;
a first ferrule surrounding said first flow line and a second ferrule surrounding second flow line, each of said ferrules having an outer wall surface that is arranged to ride in sliding contact with the converging inner wall of the adjacent entranceway; and
a first internally threaded member containing said first ferrule and a second internally threaded member containing a second internally threaded member, said first and second threaded members being arranged to mate with male threads located upon either end of said body to advance the ferrules into said entranceways wherein the ferrules are compressed, radially into sealing contact with said flow lines.

2. The connector of claim 1 wherein the outer wall surfaces of the ferrules compliments the diverging inner wall surfaces of the entrance ways.

3. The connector of claim 1 wherein a close running fit is provided between the inside diameter of said passage and the outside diameter of the flow lines.

4. The connector of claim 1 wherein each internally threaded member is a nut having a plurality of flat surfaces.

5. The connector of claim 4 wherein each nut contains breakaway parts that fracture at a predetermined torque to prevent further turning of said nut.

6. The connector of claim 5 wherein the breakaway torque of each nut is greater than that required to drive the ferrules into sealing engagement with the flow lines.

7. The connector of claim 1 wherein said flow passage also includes first and second groves located near but separate from said respective first and second converging entranceways with a first resilient seal disposed in said first groove in surrounding relationship with said first flow line and a second resilient seal disposed in said second groove in surrounding relationship with said second flow line.

8. The connector of claim 4 wherein said body contains a raised section that contains at least two opposed flat surfaces.

9. The connector of claim 7 wherein said resilient seals are O-rings.

10. A method of establishing a braze-free connection between two flow lines that includes the steps of:
inserting a first flow line into a first end of a passage that passes through a body and inserting a second flow line into a second end of said passage;
surrounding each flow line with a radially collapsible ferrule;
providing a converging entranceway at each end of said passage; and
forcing a portion of each ferrule axially into each entranceway so that each ferrules is driven radially into sealing contact with one of the flow lines.

11. The method of claim 10 including the further steps of rotatably mounting each ferrule in a member containing internal threads and mating each member with external threads located upon said body, and turning said threaded members in a direction to force the ferrules into the converging entranceways.

12. The method of claim 10 that includes the further steps of providing within said flow passage, first and second grooves located near but separate from said respective converging entranceways and; providing first and second resilient seals in said respective first and second grooves, said first seal surrounding said first flow line and said second seal surrounding said second flow line.

13. The method of claim 11 that includes the further step of disabling the internal threads of each member after the ferrules are forced into sealing contact with the flow lines.
